(19) United States
(12) Patent Application Publication
(10) Pub. No.: US 2013/0297517 A1
(43) Pub. Date: Nov. 7, 2013

(54) WEB-BASED WORKFLOW AUTOMATION SYSTEM

(71) Applicant: Arup Sinha, Scottsdale, AZ (US)

(72) Inventor: Arup Sinha, Scottsdale, AZ (US)

(21) Appl. No.: 13/466,048

(22) Filed: May 7, 2012

(51) Int. Cl. G06Q 10/06

(52) U.S. Cl. 705/301

(57) ABSTRACT

A web-based workflow automation system for developing event-based workflows is provided. The workflow automation system enables users with little or no programming knowledge to easily create and schedule event based workflows utilizing a web based interface. The workflow automation system provides a unified platform for project and workflow creation, execution, and testing.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of software development, and more particularly, to a web-based workflow automation system.

### BACKGROUND

A workflow defines a sequence of tasks to be performed to achieve an objective. Examples of workflows include workflows for business processes (e.g., processing insurance claims, payroll), and various manufacturing and fabrication processes.

Although various workflow tools have been developed, these tools suffer from deficiencies including lack of a unified platform for designing, configuring and administering the workflows. Moreover, conventional workflow tools, such as the Windows Workflow Foundation (WF) and Microsoft BizTalk Server (“BizTalk”) require highly skilled technicians to design and configure solutions. For example, Windows Workflow Foundation (WF) requires writing declarative workflows (a programming skill) and knowledge of the .NET Framework. BizTalk relies heavily on a combination of programming utilizing the Microsoft Visual Studio toolset and a Windows-based interface. Moreover, involvement and intervention of system administrators is usually necessary.

### SUMMARY OF THE INVENTION

According to the methods and systems of the present invention, a web-based workflow automation system for developing event-based workflows is provided. The workflow automation system enables users with little or no programming knowledge to easily create and schedule event based workflows utilizing a web based interface. The workflow automation system provides a unified platform for project and workflow creation, execution, and testing.

As used herein, a workflow refers to a sequence of activities. The execution outcome of an activity determines, either alone or in combination with another activity, the activity or activities that will be executed next (if any) in the workflow. By convention, the initial activity in a workflow is a Start activity. Construction of the workflow includes assigning a set of properties for the project and each set of activities in the workflow, each set of the properties based on a template. Once the workflow is constructed, the workflow can be executed on an ad hoc basis or as scheduled. In an embodiment, a Default environment is built in and does not support project execution or scheduling but can be used by a developer to define project and activity properties capable of being inherited in other environments.

A notable feature of the present invention is the inclusion of a user interface element referred to herein as a property grid wherein property values for a project, an activity, or a schedule can be user-defined. The property grid has a uniform layout, such as a tabular layout in which each row can be used to input a property value for a property. The property grid supports input of an absolute value, a reference, or an expression. Where the property value is a reference, the reference is automatically reflected across all property values which consume the reference. An expression may be written in various ways, including in the syntax of a supported high-level programming language (such as C#). Additionally, a look-up mechanism is provided for extracting and displaying historical property values so that they are selectable for input. Preferably, the property grid includes rows having one or more GUI widget for inputting/selecting an appropriate property value or indicating whether a property value is to be inherited or overridden.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows a block diagram illustrating the environment-project-workflow hierarchy, as these concepts are used in the present invention;

FIG. 2 shows an exemplary diagram of a web-based workflow automation system, according to a preferred embodiment of the present invention; and

FIG. 3 to FIG. 22 show various exemplary screens illustrating aspects of the web-based workflow automation system, according to a preferred embodiment of the present invention.

### DETAILED DESCRIPTION

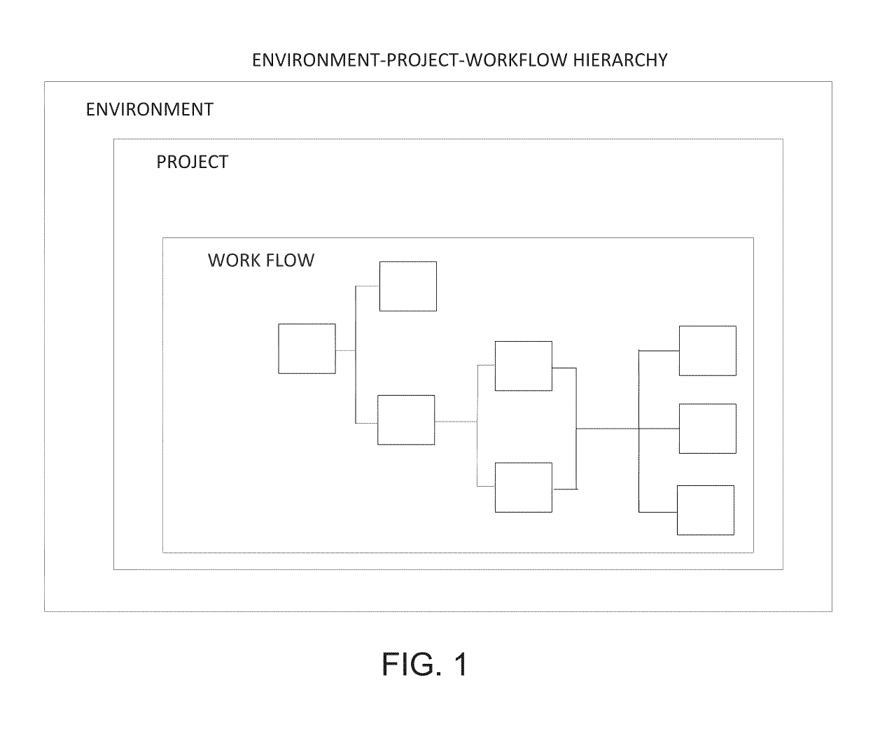

FIG. 1 illustrates the relationship between an environment, a project, and a workflow, as these concepts are employed herein. As shown, an environment can include a project, and a project, in turn, can include a workflow.

As used herein, an environment relates to the collection of resources and policies associated with a stage of development.

As used herein, a project is a management construct for an endeavor planned and designed to achieve a particular outcome. A project includes development of at least one workflow which can be executed on an ad hoc basis or scheduled.

As used herein, a workflow refers to a sequence of activities. The execution outcome of an activity determines, either alone or in combination with another activity, the activity or activities that will be executed next (if any) in the workflow. By convention, the initial activity in a workflow is a Start activity.

As used herein, an activity refers to a task which is capable of being performed using a general purpose computer, a hardware device with firmware and/or software, and/or an electro-mechanical device with a microcontroller (e.g. robotic arm).

As used herein, a schedule refers to the points in time when the Start activity of a workflow will be performed.

As used herein, a project domain refers to the general category of a project.

As used herein, the Default environment refers to a built-in environment that does not support project execution or scheduling but can be used by the developer to define project, activity or schedule (as the case may be) properties capable of being inherited in other environments.

As used herein, a property refers to one of a set of characteristics established or inherited regarding a project, an activity or a schedule.

As used herein, a property value refers to the value of a property which can be an absolute value, a reference, or an expression.

As used herein, a property grid refers to a user interface element in which property values for a project, activity or schedule (as the case may be) can be user-defined. The property grid has a consistent layout and look and feel although the contents change depending on the project, activity or schedule selected.

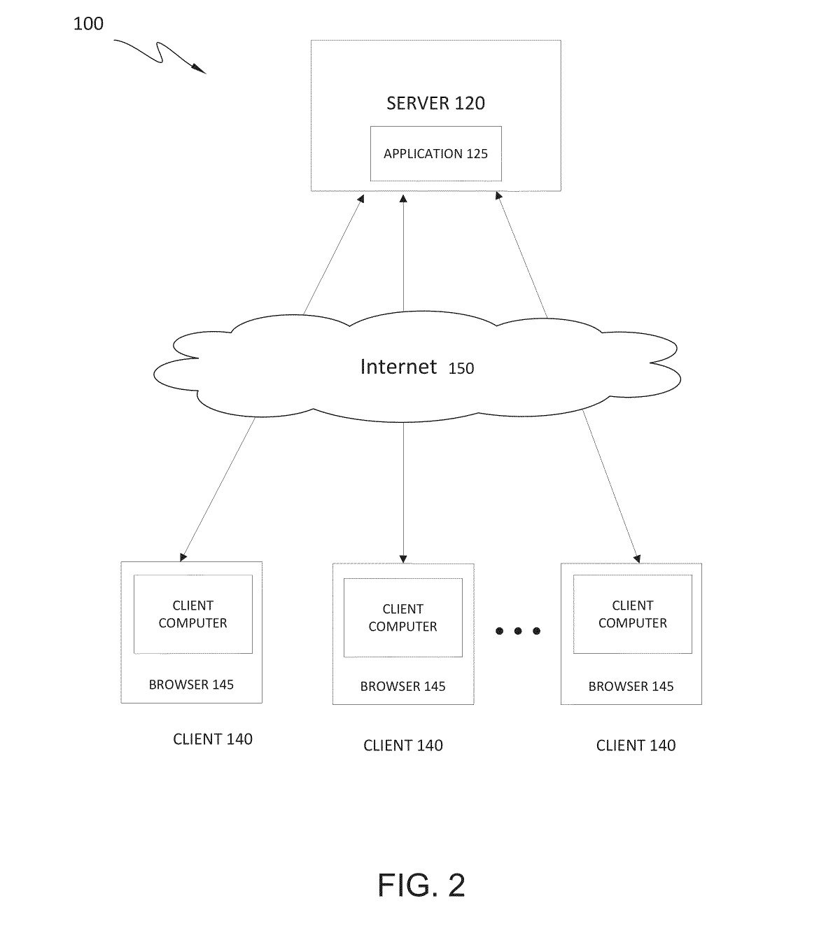

Referring to FIG. 2, an exemplary diagram of a web-based workflow automation system 100 is shown. As depicted, the workflow automation system 100 includes a distributed application which is partitioned between a service provider (server 120) and a plurality of service requesters (clients 140). Under this arrangement, a request-response protocol, such as hypertext protocol (HTTP), can be employed such that a client 140 can initiate requests for services from the server 120, and the server 120 can respond to each respective request by, for example, executing an application 125 on the server 120, and (where appropriate) sending results to the client 140. It is to be understood that in some embodiments, however, substantial portions of the application logic may be performed on the client 140 using, for example, the AJAX (Asynchronous JavaScript and XML) paradigm to create an asynchronous web application. Furthermore, it is to be understood that in some embodiments the application 125 can be distributed among a plurality of different servers 120 (not shown).

Preferably, the illustrated entities (the server 120 and the clients 140) communicate via the Internet 150 which provides a path for data communication, and allows exchange of information signals. Although the Internet 150 is depicted as being used for communication among the illustrated entities, it is to be understood that other network elements could, alternatively, or in addition, be used. These include any combination of wide area networks, local area networks, public switched telephone networks, wireless or wired networks, intranets, the Internet or any other distributed processing network or system. In still other embodiments, the workflow automation system 100 can be implemented on a single standalone computer system.

In the following description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications 125 written in HTML, PHP, Javascript, jQuery accessible by the clients 140 using a suitable browser 145 (e.g., Internet Explorer, Mozilla Firefox, Google Chrome, Opera).

Project/Activity/Schedule Properties and the Property Grid

A notable feature of the present invention is the inclusion of a user interface element referred to herein as a property grid wherein property values for a project, an activity, or a schedule can be user-defined. As will be apparent, the property grid has a consistent layout and look and feel although the contents can change depending on the project, activity or schedule selected.

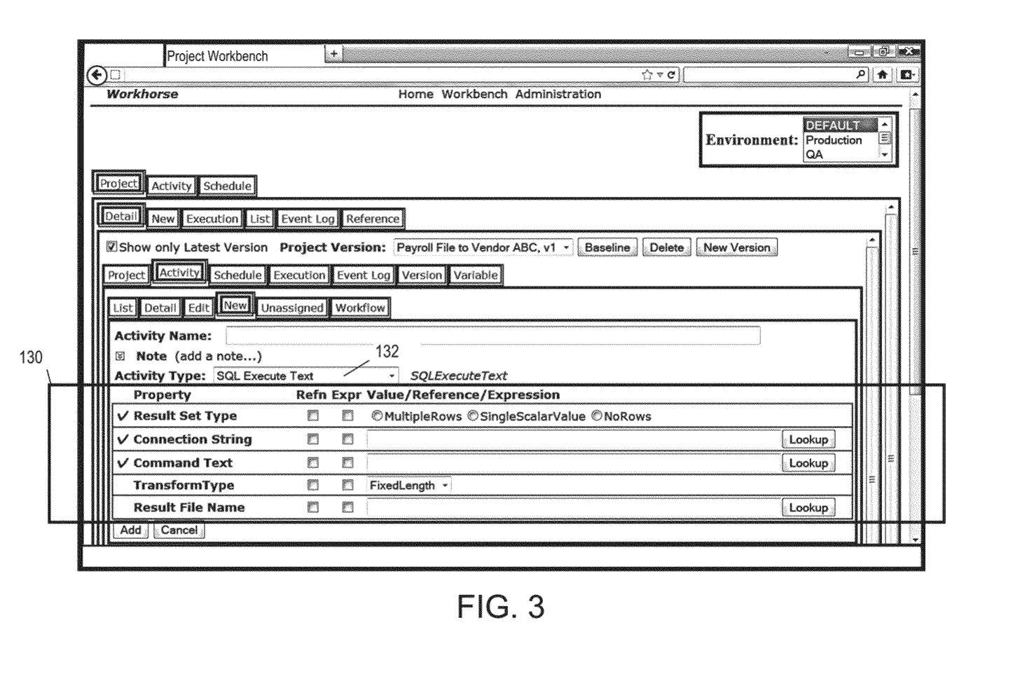

To illustrate the property grid feature, FIG. 3 shows an exemplary screen including a property grid 130 for defining the properties of a particular “activity”. In this case, the activity is of activity type “SQL Execute Text”, which was selected from a drop-down menu 132 having predefined activity types. The set of activity types available in the drop-down menu 132 will vary depending on the project domain. In this example, the list of activity types will include all of those that typically are employed in the project domain “Information Technology General”. It is to be understood that the property grid 130 is shown for illustrative purposes. Further, it is to be understood that although this example involves a property grid for defining the properties of an activity, property grids used for defining the properties of projects and schedules are also available and have similar features.

To ensure data integrity, the property grid 130 includes appropriate controls to input data values for each property. In particular, preferably, the property grid 130 can be configured such that the only allowable property values, where appropriate, are an absolute value, a reference (wherein a reference checkbox for the property can be checked) or an expression (wherein an expression checkbox for the property can be checked). Additionally, the input data can be validated for data type compatibility, e.g., where a property value can only be an integer, an alphabetic value would not be accepted.

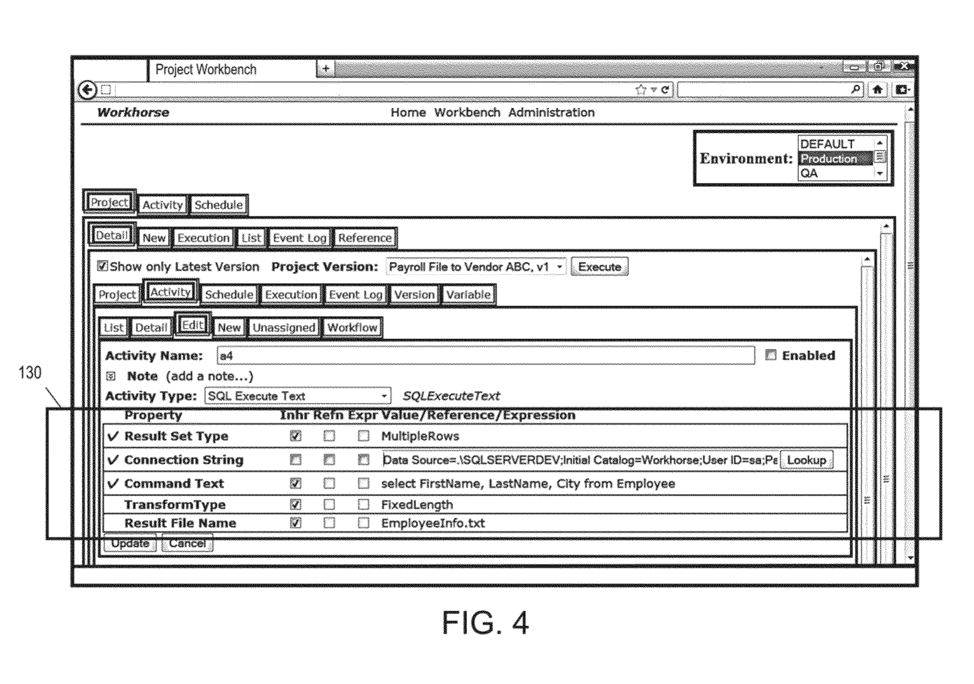

Referring to FIG. 4, an exemplary screen having a property grid 130 in a Production environment is illustrated. As shown, the “Payroll File to Vendor ABC” project is opened, and the user has elected to inherit each of the properties of the selected activity except the “Connection String” property wherein the user has inputted an expression. The value inputted for the “Connection String” property is different from the one assigned to this property in the Default environment. In general, a property value in a non-Default environment (such as the Production environment) can be inherited (wherein the inherited checkbox for the property can be checked) from the Default environment.

Each property of a project, activity, or schedule is represented in the pertinent property grid by a row. For example, the SQL Execute Text activity type has the properties Result Set Type, Connection String, Command Text, Transform Type, and Result File Name. Where input values for a property are mandatory, a visual indicator, such as a check mark (as shown) is displayed next to the property. As illustrated in FIG. 4, the Result Set Type, Connection String, and the Command Text properties are mandatory.

Preferably, an absolute value for a property can be input by un-checking the reference checkbox, the expression checkbox and the inherit checkbox (if applicable). The appropriate control to input an absolute value appears next to the property name.

Preferably, property values can be edited in any environment. For property values created in the Default environment, the property values are automatically inherited in other environments but can be expressly overridden. Overriding a property value is accomplished by un-checking the inherit checkbox corresponding to the property in the property grid. The property value is then overridden by providing an absolute value, a reference, or an expression.

Property References

Property references are used when a particular property value is reused across projects or activities. For example, several projects may need to use the same project type property value Working Folder Path, e.g. C:\Users\arup\Documents\WorkingFolder. If for some reason, the property reference value changes, then the new property reference value is automatically applied for all properties that are using the property reference.

The Reference checkbox that appears after the Property Name in the property grid is checked while creating or editing a project/activity to indicate a reference. Clicking the reference checkbox changes the value textbox into a drop-down with a list of available references. References are created and managed independently of projects and activities.

Creating a Property Reference

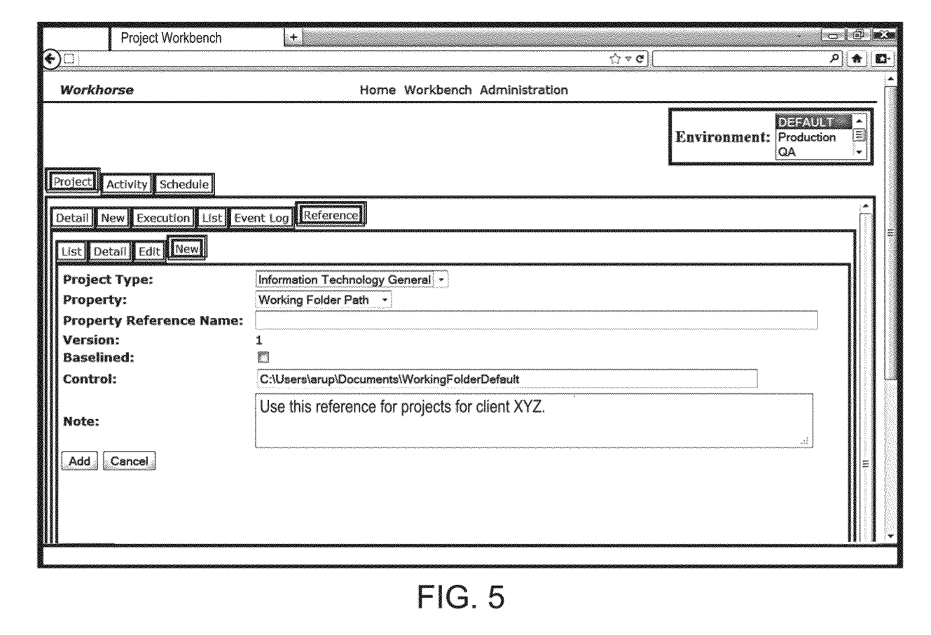

FIG. 5 illustrates an exemplary screen for creating a project type property reference. To create a project/activity type property reference, the Workbench tab on the main menu is clicked, followed by the Project/Activity tab followed by the Reference tab and finally the New tab is clicked. A project/activity type is then selected from the Project/Activity Type drop-down list. All properties belonging to the selected Project/Activity Type appear in the Property drop-down list. The property whose reference is to be created is selected from the Property drop-down list. A suitable Property Reference Name is then entered. Depending on the type of the property that has been selected, a suitable input control appears next to the Control field. A suitable value is entered/selected for the Control field. Notes can be entered in the Note field. Checking the Baseline checkbox renders this property reference un-editable. The Add button is clicked to add this Project/Activity Type Property Reference.

Viewing a Property Reference

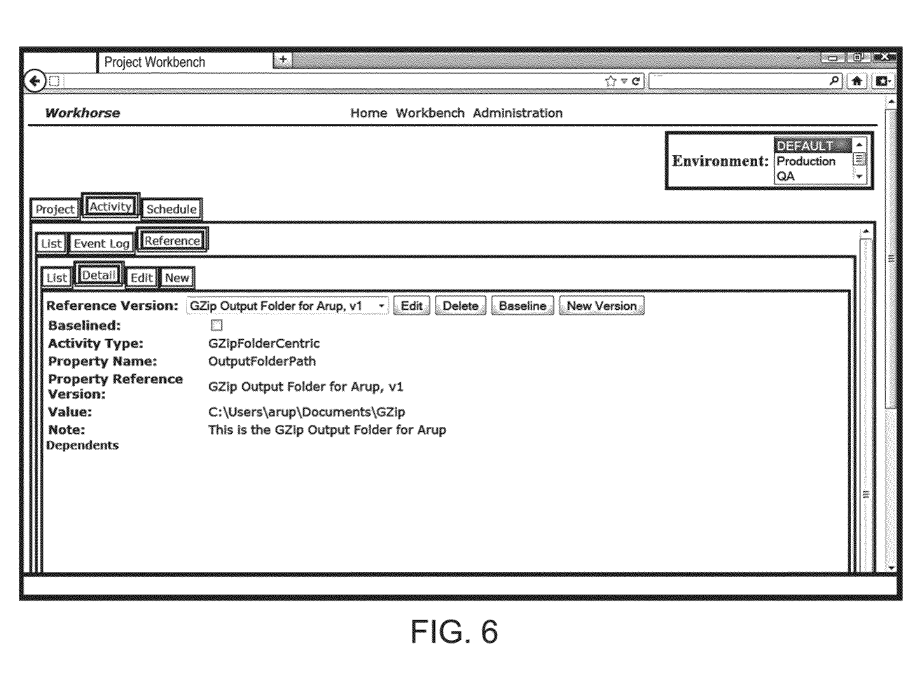

FIG. 6 illustrates an exemplary screen for viewing an activity type property reference. To view a project/activity type property reference, the Workbench tab on the main menu is clicked, then the Project/Activity tab on the Workbench page is clicked. The Reference tab is clicked. And then the Detail tab is clicked. A reference version is selected from the Reference Version drop-down list. The details of the Project/Activity Type Property Reference version appear along with a Dependents section that lists all dependent project versions/activities. The Edit, Delete, Baseline and New Version buttons will appear if the reference version has not been based. Only the New Version button will appear for a baselined reference version.

Editing a Property Reference

For those property references that qualify to be edited, the property reference is first viewed (as above) and then the Edit button which appears next to a drop-down list is clicked to edit the property reference. An Update button is clicked to finalize the changes.

Creating a New Version of a Property Reference

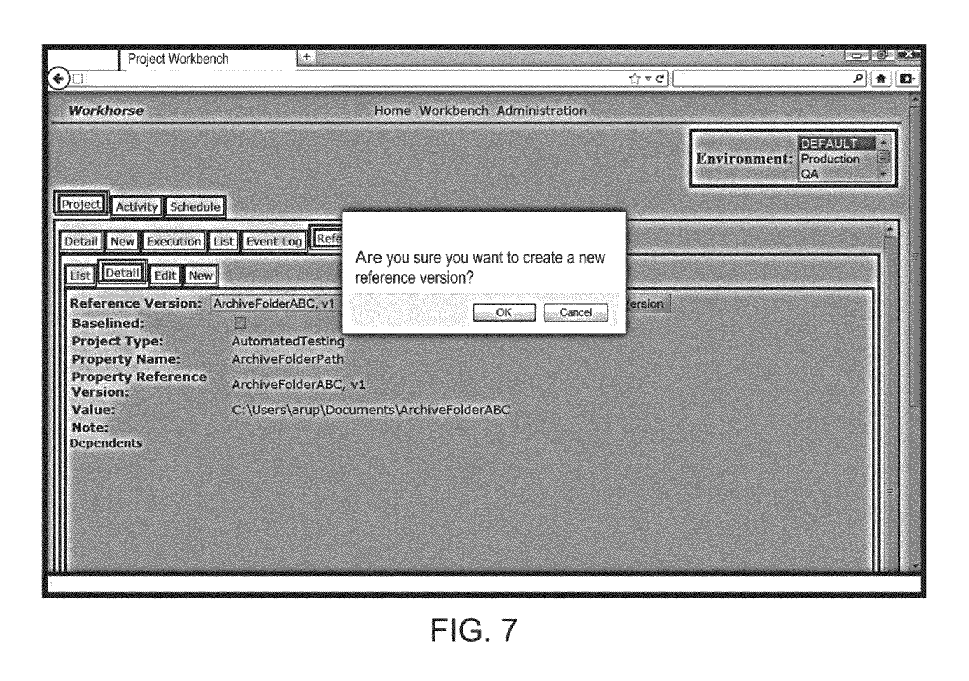

FIG. 7 illustrates an exemplary screen for creating a new version of a property reference. (Navigation: Workbench tab Project/Activity tab Reference tab Detail tab Reference Version drop-down list). A property reference version is viewed and the New Version button appears next to the drop-down list. A modal confirming the request to create a new version appears. On user confirmation, a new version is created.

Property Grid Expression Feature

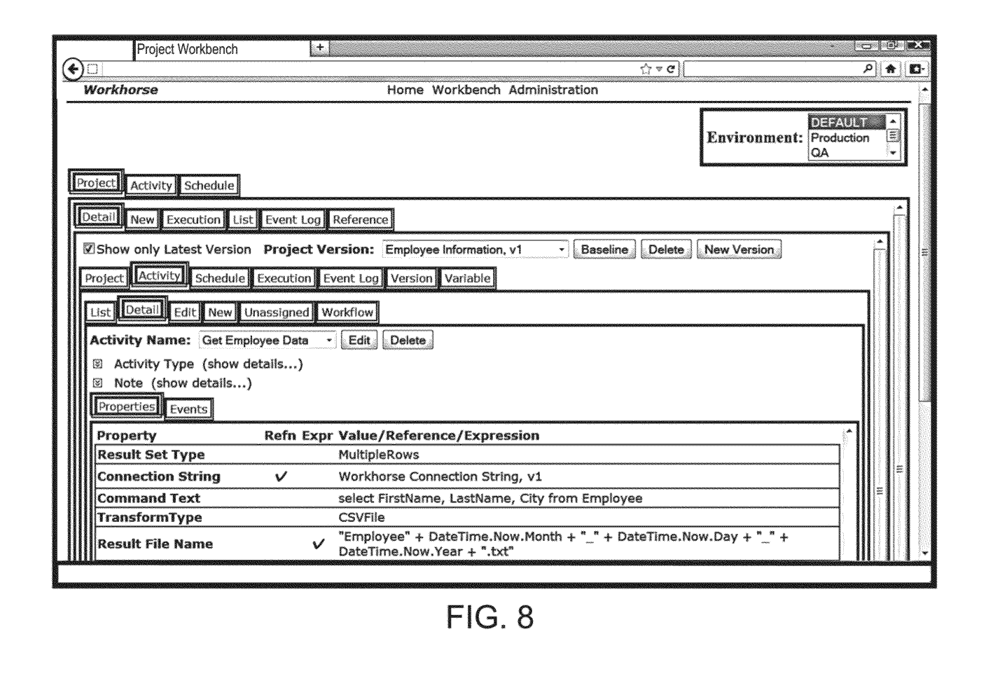

FIG. 8 illustrates an exemplary screen for setting an expression as a property value. In this example, a Microsoft C# programming language expression that evaluates to a property value is used in the property grid by checking the Expression checkbox. A C# expression is used that evaluates to a value with the same data type as that of the property. The screen illustrates how an out file name can have the current date embedded in the file name. Note that DateTime.Now.Month, DateTime.Now.Day and DateTime.Now.Year are the C# syntax to get the current month, day and year respectively. Although the illustrated example shows a C# expression, it is to be understood that the present invention could support expressions written in other high level languages.

Environments

Generally, an environment relates to the policies and available resources under which a project is created, enabled or executed. E.g., Production environments typically have stringent access control, change management, logging, data control, etc., as opposed to development environments. New environments can be added and existing environments deleted in the Administration page. The Default environment does not support project execution. Projects created in the Default environment are visible in other environments and can be enabled or disabled for execution in any other environment. The properties of a project created in the Default environment can be overridden in non-Default environments. However, projects created in a non-Default environment can only be enabled or disabled for execution in their creation environment and are not visible in any other environment. Moreover, schedules can only be created in non-Default environments and are only visible in the environment where they were created.

Creating a New Environment

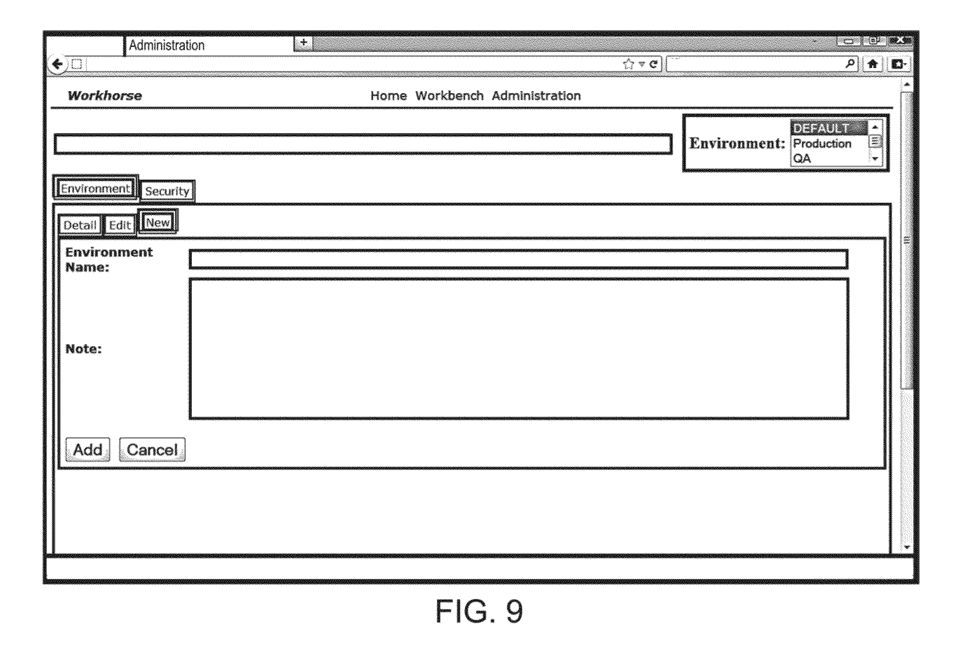

FIG. 9 illustrates an exemplary screen for creating a new environment. To arrive at this screen, the Administration tab on the main menu is clicked. Then, the Environment tab of the Administration page is clicked. The New tab under the Environment tab space is clicked, and the Environment Name and Description are entered. To add the environment, the Add button is clicked. The Detail tab under the Environment tab will be displayed with the new environment details and a “success” message highlighted.

Projects

A project is a management construct to achieve a certain objective. A project includes at least one workflow which can be executed via a schedule or on an ad-hoc basis. A project created in the Default environment is automatically inherited across other environments but may be overridden. When a project created in the Default environment is inherited in another environment, all project components (e.g., activities) are also inherited. A project created in a non-Default environment cannot be inherited.

A project is created by selecting a template from a predefined set of project type templates and then configured by setting the project attributes and property values. Multiple project type templates address different vertical domains. For example, the Information Technology General template addresses a generalized business systems domain for common information technology (IT) activities such as copying files, sending email, encrypting files, etc. Plug-in technology enables project templates for diverse domains and verticals to be integrated seamlessly.

Change management is achieved utilizing versioning. A newly created project is assigned a “version 1”. A project version is editable until a baseline is created utilizing the Baseline button adjacent to the Project Version drop-down in the Project tab General tab. Clicking the New Version button next to the Project Version drop-down in Project tab General tab also baselines the older version and renders it un-editable in addition to creating a newer version with the same attributes and properties as the older version. Only the latest project version is editable, unless it has been baselined.

Creating a New Project

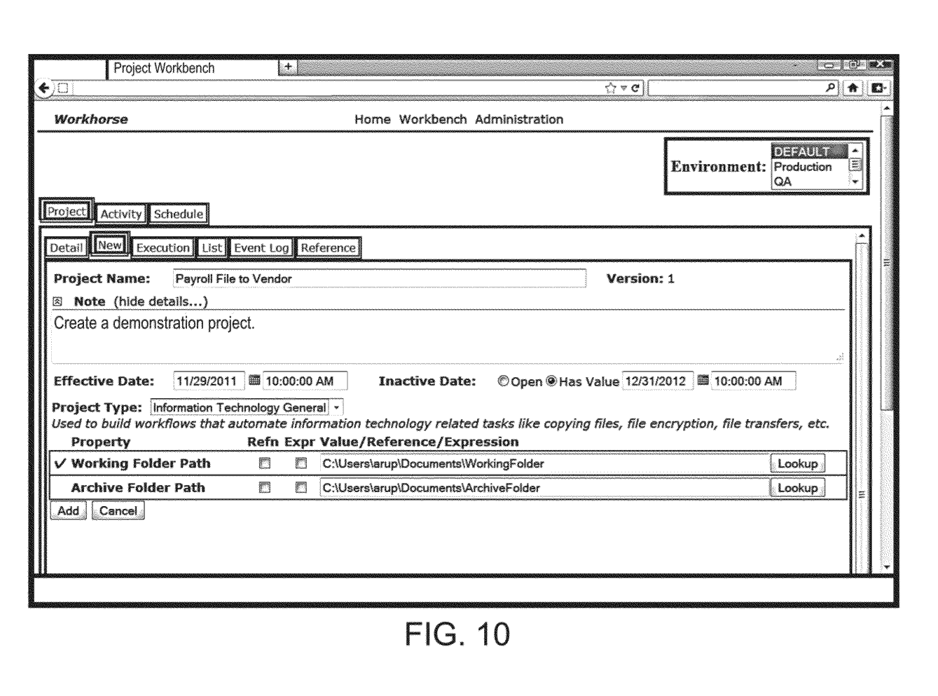

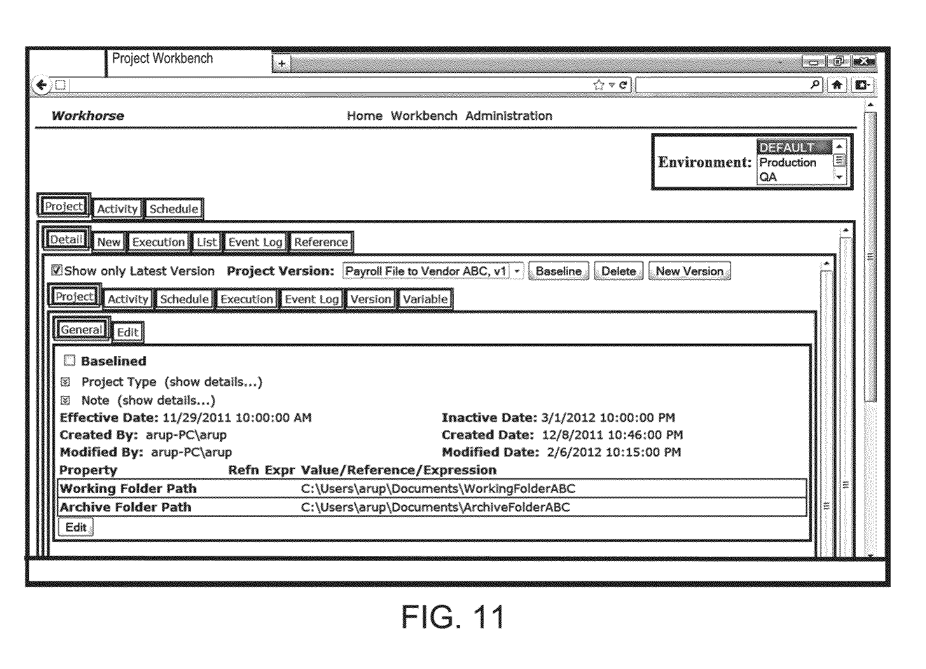

FIG. 10 illustrates an exemplary screen for creating a new project. (Navigation: Workbench tab→Project tab→New tab). Once on this screen, the user enters the Project Name (e.g., “Payroll File to Vendor”), the Effective Date (e.g., 11/29/2011 10:00:00 AM) and Inactive Date (e.g., 12/31/2012 20:00 AM). An appropriate type of project is selected from the Project Type drop-down list. In this example, a project type of Information Technology General has been selected. The properties of the selected project type appear below the drop-down list. The properties of the selected project type are entered, namely the location of the Working Folder Path (“C:\Users\arup\Documents\WorkingFolder”) and Archive Folder Path (“C:\Users\arup\Documents\ArchiveFolder”). To create the project, the Add button is clicked. The Detail tab under the Project tab then will be displayed with the new project details, as shown in FIG. 11.

Viewing a Project

(Navigation: Workbench tab→Project tab→Detail tab→Project Version drop-down list→Project tab→General tab). A project version is selected from the Project Version drop-down list. The project attributes (Baselined, Enabled, Project Type, Note, Effective Date, Inactive Date, Created By, Created Date, Modified By and Modified Date) and project type properties are displayed below the drop-down list.

Baselining a Project

(Navigation: Workbench tab→Project tab→Detail tab→Project Version drop-down list→Baseline button). An existing project version is viewed. The Baseline button appears next to the Project Version drop down list if the project version has not yet been baselined and the project is being viewed in the creation environment. The Baseline button is clicked to baseline the project version.

Deleting a Project

(Navigation: Workbench tab→Project tab→Detail tab→Project Version drop-down list→Delete button). Project versions that are not baselined can be deleted in their creation environment. An existing project version that qualifies to be deleted is viewed and the Delete button appears next to the Project Version drop down list. The Delete button is clicked to delete the project version.

Editing a Project

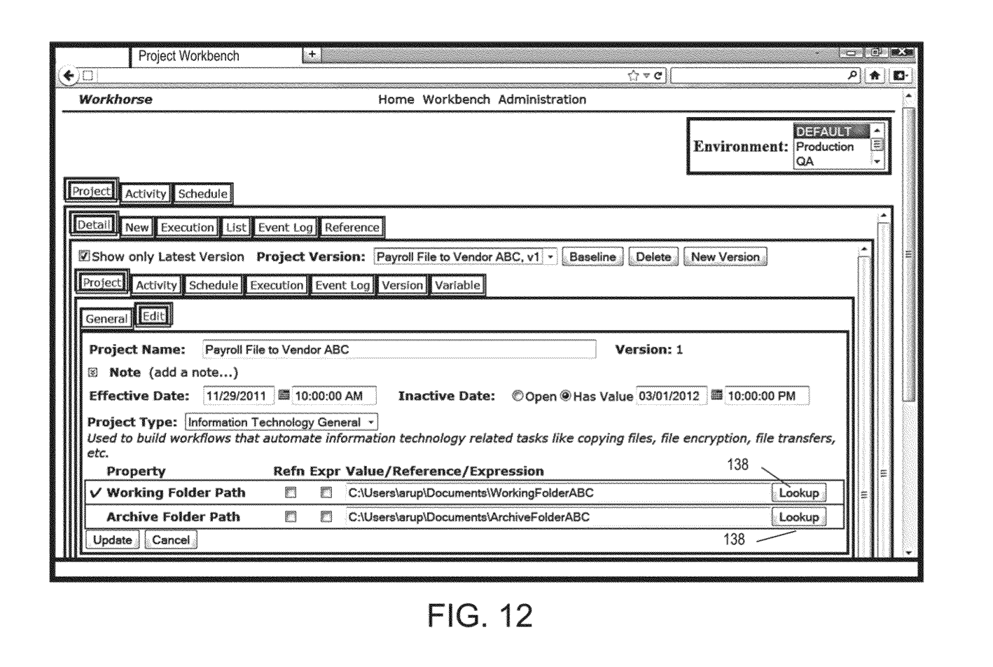

FIG. 12 illustrates an exemplary screen for editing a project. (Navigation: Workbench tab→Project tab→Detail tab→Project Version drop-down list→Project tab→General tab→Edit button). Baselined project versions cannot be edited. Project versions that have been created in the Default environment and are not baselined can be edited in all environments. Project versions that have been created in a non-Default environment and are not baselined can be edited only in the creation environment. A project version that qualifies to be edited is viewed and the Edit button appears at the bottom. The Edit button is clicked to edit the project version. The Project Type cannot be changed once a project has been created. The project attributes like Project Name, Note, Effective Date and Inactive Date fields can be edited only in the project creation environment. The Project Type properties can be edited in the creation environment. For a project created in the Default environment, the Project Type properties can be overridden in non-Default environments. The Update button is clicked to finalize the changes.

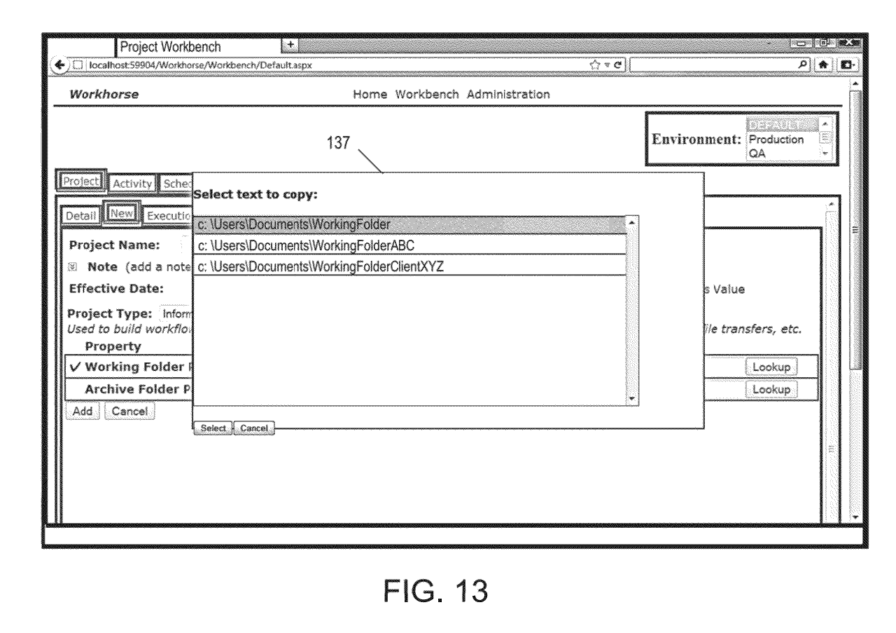

A notable feature of the present invention is a lookup button 138 which appears at the end of text input boxes. Clicking the lookup button 138 (as shown in FIG. 12) brings up a pop-up list 137 (as shown in FIG. 13) with absolute values that have previously been used, and a selection from the pop-up list 137 can then be made. Note that a physical copy of the value will be made and stored unlike in the case of reference value where only the reference will be made.

Enabling/Disabling a Project

(Navigation: Project tab→Detail tab→Project Version drop-down list→Project tab→General tab→Enable button). Project versions cannot be enabled or disabled in the Default environment since they cannot be executed there. Project versions can be enabled or disabled in non-Default environments by clicking the Enable Project/Disable Project button that appears at the bottom.

Creating a New Project Version

(Navigation Workbench tab→Project tab→Detail tab→Project Version drop-down list→New Version button). An existing project version is viewed. The New Version button appears next to the Project Version drop down list if the project version is being viewed in the creation environment. The New Version button is clicked to create a new project version.

Viewing Project Execution

(Navigation: Workbench tab→Project tab→Detail tab→Project Version drop-down list→Project tab→Execution tab). An existing project version is viewed in a non-Default environment. The Execution tab under the Project Detail tab space is clicked.

Activities

An activity refers to a task which is capable of being performed on a computer or a computer assisted device (e.g. robotic arm). The execution outcome of an activity determines, either alone or in combination with another activity, the activity that will be executed next (if any) in the workflow. The start activity is the root activity or starting point of the workflow. An activity is created by selecting a template from a predefined set of activity type templates and then configured by setting the activity property values. An activity can only be created in the environment the project that it belongs to is created. Properties of an activity created in the Default environment can be overridden in non-Default environments.

The topics discussed in this section are in context to an existing project version is selected (see Viewing a Project). The Activity tab under the Project tab Detail tab is clicked and tabs to perform various activity related functions appear.

Creating a New Activity

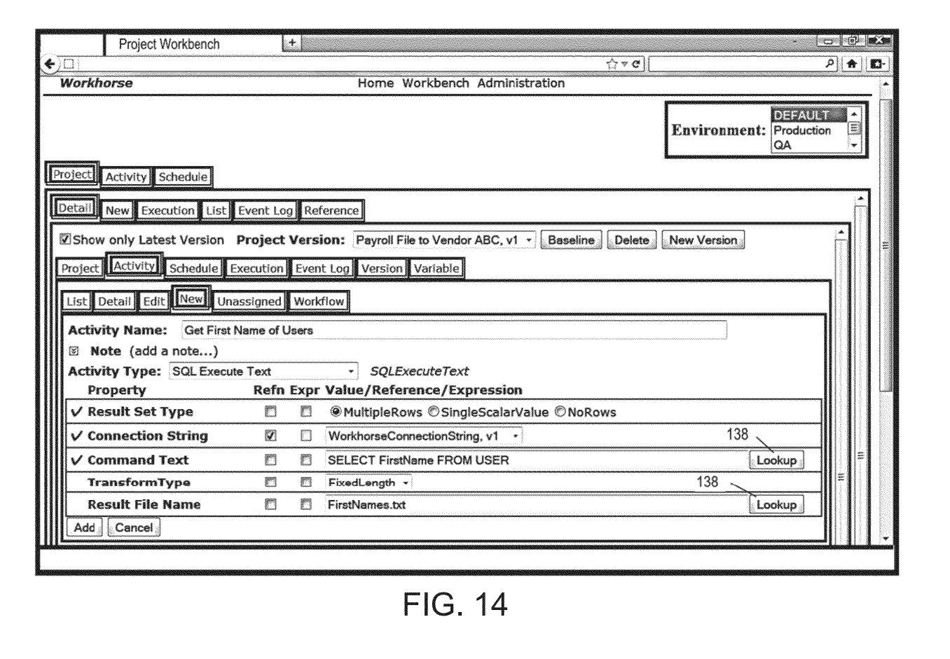

FIG. 14 illustrates an exemplary screen for creating a new activity. (Navigation: Workbench tab→Project tab→Detail tab→Project Version drop-down list→Activity tab→New tab). The New tab under the Activity tab space is clicked. The Activity Name (“Get First Name of Users”) is entered. An appropriate type of activity is selected from the Activity Type drop-down list. In this example, an activity type of SQL Execute Text has been selected. The properties of the selected activity type appear below the drop-down list. The properties of the selected activity type are entered, namely Result Set Type (value of “MultipleRows”), Connection String (reference to “WorkhorseConnectionString, v1”), Command Text (value of “SELECT FirstName FROM USER”), Transform Type (value of “FixedLength”) and Result File Name (value of “FirstNames.txt”). The Add button is clicked. The Detail tab under the Activity tab under the project version gets displayed with the new activity details.

Viewing an Activity

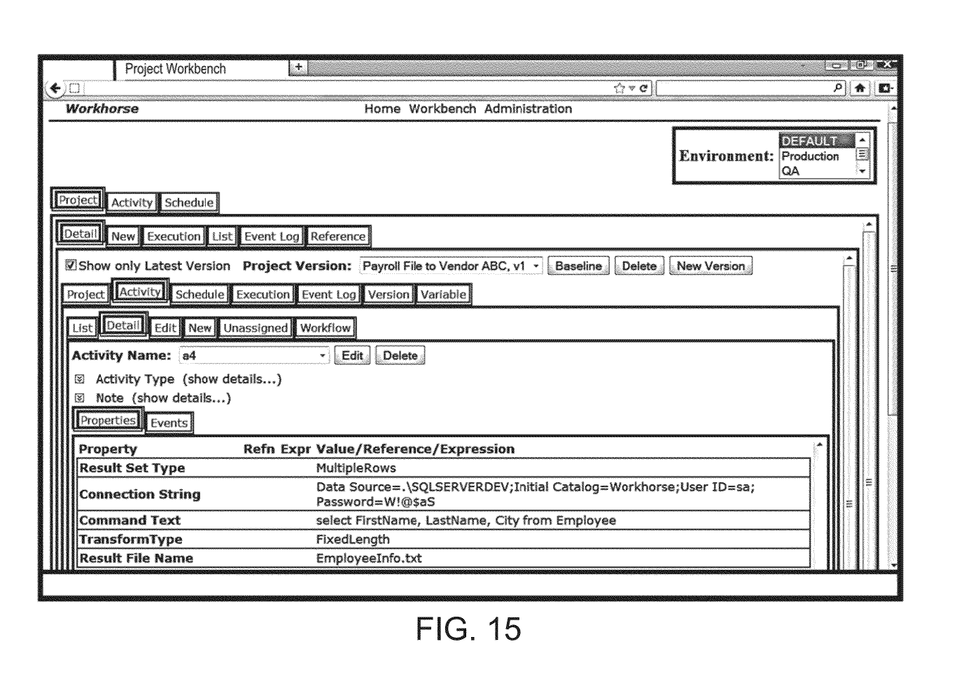

FIG. 15 illustrates an exemplary screen for viewing an activity. (Navigation: Workbench tab→Project tab→Detail tab→Project Version drop-down list→Activity tab→Detail tab).The Detail tab under the Activity tab space is clicked. The desired activity is selected from the Activity Name drop-down list. The activity attributes (Enabled, Activity Type and Note) are displayed below the drop-down list. The activity type properties are displayed under the Properties tab and the activity type events are displayed under the Events tab below the drop-down list.

Viewing Activities

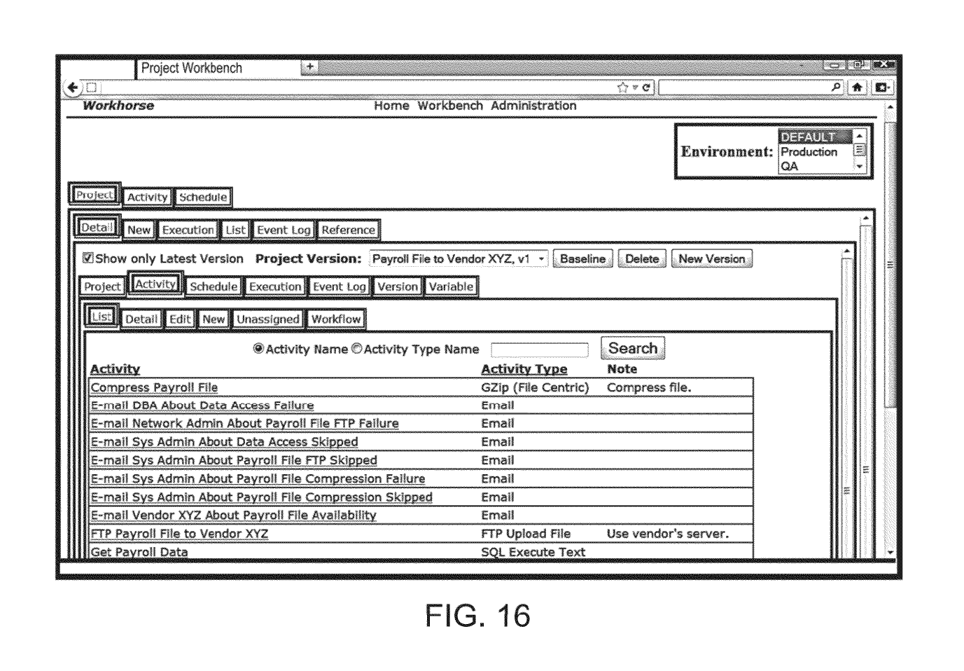

FIG. 16 illustrates an exemplary screen for viewing an activity. (Navigation: Workbench tab→Project tab→Detail tab→Project Version drop-down list→Activity tab→List tab). The List tab under the Activity tab space is clicked. All activities that are a part of the project are displayed.

Viewing UnassignedActivities

(Navigation: Workbench tab→Project tab→Detail tab→Project Version drop-down list→Activity tab→Unassigned tab). The Unassigned tab under the Activity tab space is clicked. The activities that are not a part of the Start sub-tree are displayed. These activities will not be executed when the project is executed.

Viewing a Workflow

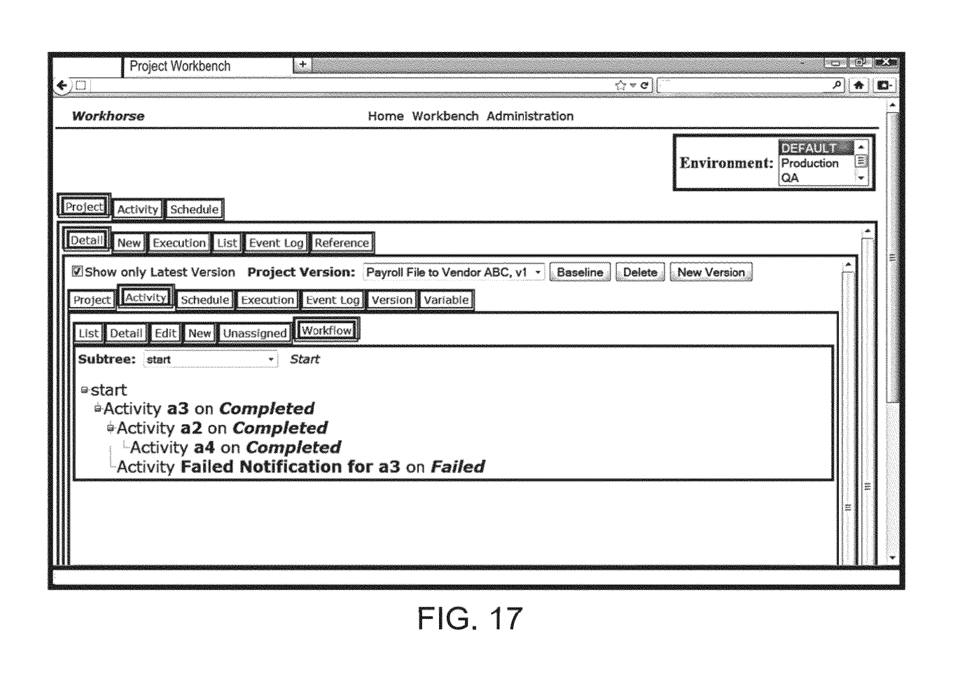

FIG. 17 illustrates an exemplary screen for viewing a workflow. (Navigation: Workbench tab→Project tab→Detail tab→Project Version drop-down list→Activity tab→Workflow tab). The Workflow tab under the Activity tab space is clicked. The desired activity sub-tree is selected from the Sub-tree drop-down list. Note that the sub-tree with the Start root node only gets executed during project execution. The non-Start root node sub-trees' are orphans and will not get executed unless they are attached to the Start sub-tree.

Managing Activity Events

(Navigation: Workbench tab→Project tab→Detail tab→Project Version drop-down list→Activity tab→Detail tab→Events tab). An existing activity is selected (see Viewing an Activity). The Events tab is clicked. Activity events can be edited for an activity that is editable. If a handler activity exists for an event, the Change button is displayed otherwise an Add button is displayed. The Add/Change button is clicked. The new handler activity or no activity (None option) is selected from a popup list that displays a list of available handler activities. Note that the popup list displays activities that have not already been used as an event handler activity elsewhere. The Update button is clicked to confirm the selection.

Deleting an Activity

(Navigation: Project tab→Detail tab→Project Version drop-down list→Activity tab→Detail tab→Delete button). An activity belonging to a project version that is not baselined can be deleted in the creation environment. An existing activity that qualifies to be deleted is viewed and the Delete button appears next to the Activity Name drop-down list. The Delete button is clicked to delete an activity. If other activities depend on an activity, then that activity cannot be deleted.

Editing an Activity

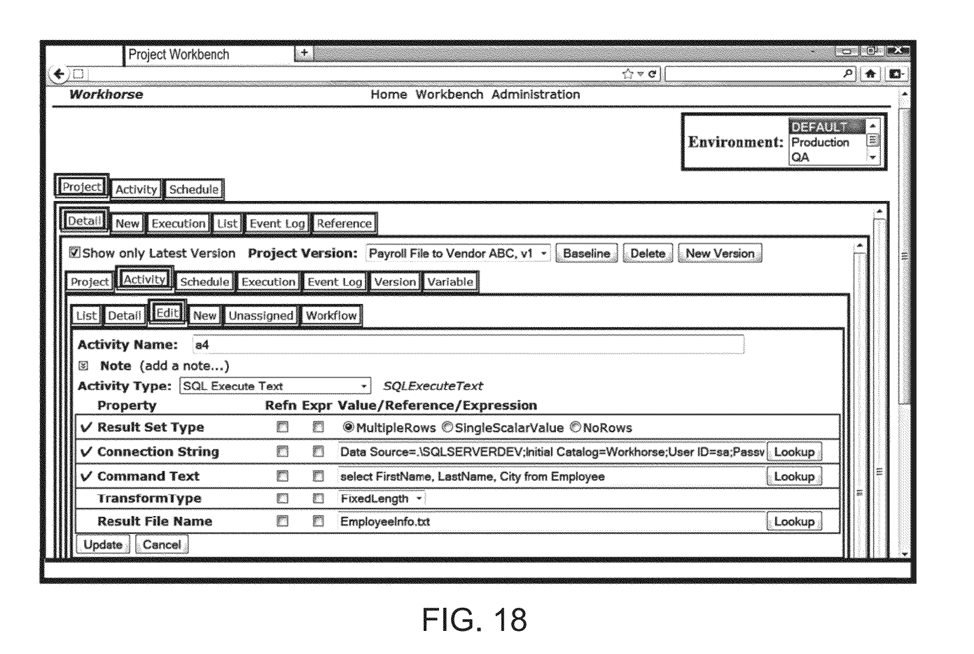

FIG. 18 illustrates an exemplary screen for editing an activity. (Navigation: Workbench tab→Project tab→Detail tab→Project Version drop-down list→Activity tab→Detail tab→Edit button). The same rules that apply for editing a project version apply to editing an activity that belongs to the project version. An activity that qualifies to be edited is viewed and the Edit button appears at the bottom. The Edit button is clicked to edit the activity. The Activity Type cannot be changed once an activity has been created. The Activity Name and Note can be edited only in the activity creation environment. The Activity Type properties can be edited in the creation environment. For an activity created in the Default environment, the Activity Type properties can be overridden in non-Default environments. The Update button is clicked to finalize the changes.

Enabling/Disabling an Activity

(Navigation: Workbench tab→Project tab→Detail tab→Project Version drop-down list→Activity tab→Detail tab→Edit button). An activity cannot be enabled/disabled in the DEFAULT environment since this environment does not support project execution. An activity can be enabled/disabled in all non-DEFAULT environments by clicking the Edit button and checking or un-checking the Enabled checkbox and then clicking the Update button.

Schedules

A schedule is used to execute a project. Workhorse schedules are environment specific and hence can only be created and executed in non-DEFAULT environments. Schedules cannot be inherited across environments and are only visible in the environment that they have been created.

The topics discussed in this section are in context to an existing project version is selected (see Viewing a Project). The Activity tab under the Project tab→Detail tab is clicked and tabs to perform various activity related functions appear.

Creating a New Schedule

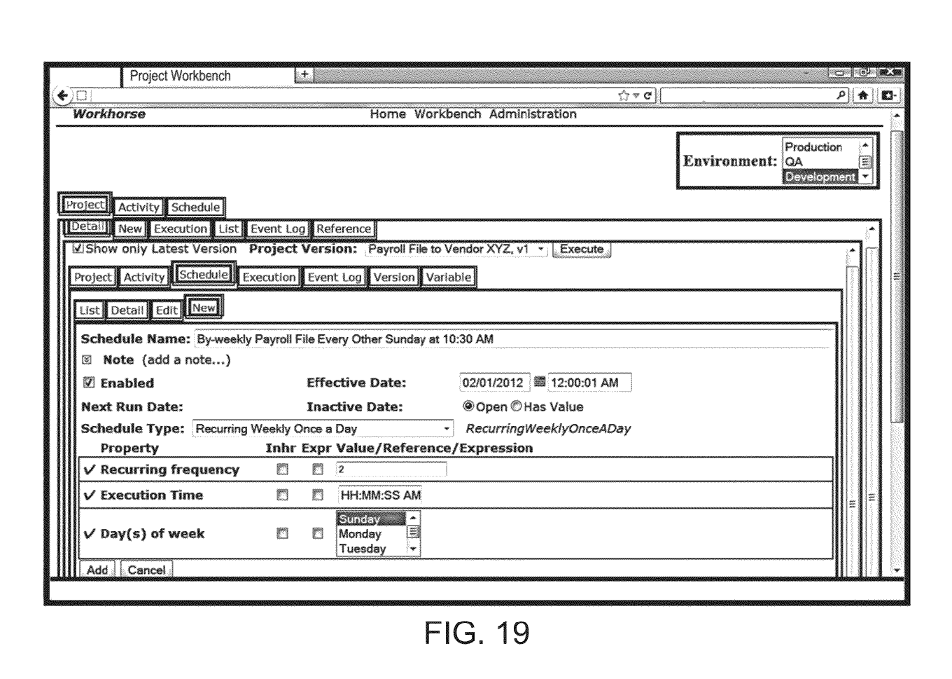

FIG. 19 illustrates an exemplary screen for creating a new schedule. (Navigation: Workbench tab→Project tab→Detail tab→Project Version drop-down list→Schedule tab→New tab). A non-Default environment is selected from the Environment list-box. The New tab under the Schedule tab space is clicked. The Schedule Name (“By-weekly Payroll File Every Other Sunday at 10:30 AM”) is entered. An appropriate type of schedule is selected from the Schedule Type drop-down list. In this example, a schedule type of Recurring Weekly Once a Day has been selected. The properties of the selected schedule type appear below the drop-down list. The properties of the selected schedule type are entered, namely Recurring Frequency (value of “2” indicating by-weekly), Execution Time (reference to “10:30:00 AM”) and Day(s) of Week (value of “Sunday” selected in list box). The Add button is clicked. The Detail tab under the Schedule tab under the project version gets displayed with the new schedule details. The Next Run Date signifies the date and time that this project version will be executed next via this schedule.

Viewing a Schedule

(Navigation: Workbench tab→Project tab→Detail tab→Project Version drop-down list→Schedule tab→Detail tab). A non-Default environment is selected from the Environment list-box. The Detail tab under the Schedule tab space is clicked. The desired schedule is selected from the Schedule Name drop-down list. The schedule attributes (Enabled, Next Run Date, Effective Date, Inactive Date, Schedule Type and Note) and schedule type properties are displayed.

Viewing Schedules

(Navigation: Workbench tab→Project tab→Detail tab→Project Version drop-down list→Schedule tab→List tab). A non-Default environment is selected from the Environment list-box. The List tab under the Schedule tab space is clicked. All schedules that are a part of the project are displayed.

Editing a Schedule

(Navigation: Workbench tab→Project tab→Detail tab→Project Version drop-down list→Schedule tab→Detail tab→Edit button). A schedule that qualifies to be edited is viewed and the Edit button appears at the bottom. The Edit button is clicked to edit the schedule. The Schedule Type cannot be changed once a schedule has been created. The Schedule Type properties can be edited. The Update button is clicked to finalize the changes.

Event-Based Workflow Supporting Tree-Based Execution

A project requires an activity of type Start that is used to initiate execution. A typical activity type supports a minimum of four events: Failed, Skipped, Completed and Started. The present invention supports the creation of custom activity types that have more than the four standard events.

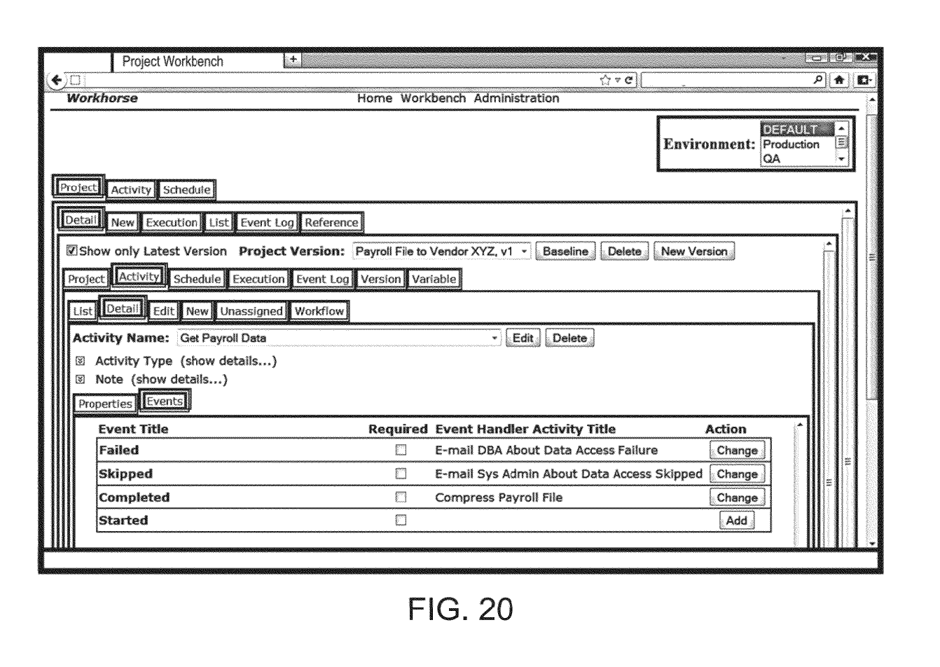

The detail view of an activity has two tabs: Properties and Events. As shown in FIG. 20, the Events tab displays the events that may occur during the execution of the activity and the handler activities that are executed after each specific event is raised. Note that each activity in a project workflow may be executed at the most one time. Each activity may participate as a handler activity only once excluding the Start activity. The Start activity initiates project execution and hence does not participate as a handler activity.

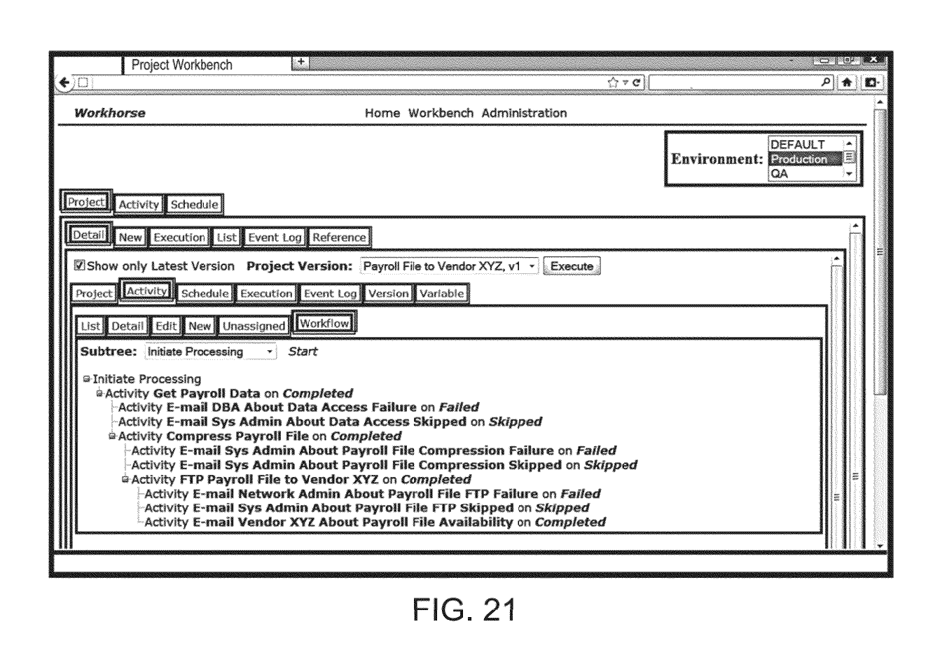

FIG. 21 shows an exemplary screen illustrating a workflow to process a payroll file. As illustrated, the Compress Payroll File activity is executed when the activity Get Payroll Data is completed causing the Completed event to be raised.

Configuration of Events

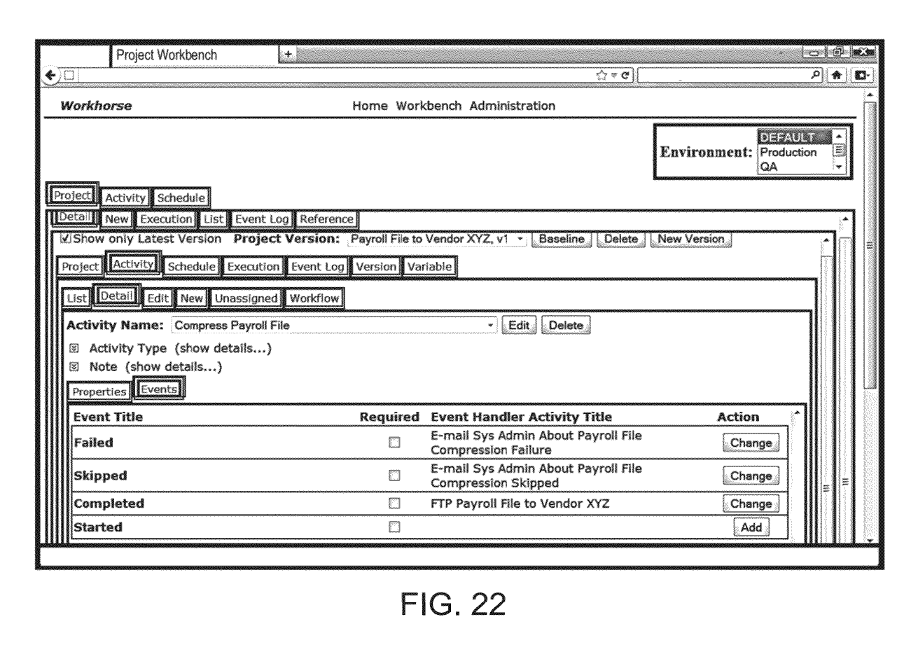

Referring to FIG. 22, activity events are viewed by selecting the Events tab from an activity detail. The Events tab is clicked to view the events that may be raised when the activity is executed and the corresponding activity that will be executed on the generation of any particular event. The Events tab displays a table with rows for each event and an Add/Change button to add or change an event handler activity.

The Add button is displayed for events that have not yet been assigned an event handler activity. The Change button is displayed for events that have been assigned an event handler activity. Clicking an Add or Change button in the Events view brings up a popup with a list of activities that have not yet been assigned to the workflow.

To un-assign an event handler activity from an event, the Change button is clicked, the option None is selected from the popup list and the Update button clicked. To reassign an event handler activity, the Change button is clicked, the new event handler activity is selected from the popup list and the Update button clicked.

Configuration of events is only permissible for activities in their creation environment. For an activity created in the Default environment, configuration of events is only possible in the Default environment and the event configuration is inherited across all other environments where workflow modifications are not permissible.

Display Context Change Automatically to Reflect Environment Change

The environment selection list on the top right corner of the main page lists the available environments with the currently active environment selected. When the currently active environment is changed in the environment selection list for a project created in the Default environment, the project and activity attributes, property values and action controls (e.g., Create, Delete, Execute buttons) change automatically to reflect the environment change. Note that a project created in the DEFAULT environment is visible across all environments and the constituent activity property values may be overridden in other environments.

Entity Relationship (E-R) Diagram Notes

In the above description of the present invention, exemplary screen layouts were provided to illustrate various features of the present invention. It is to be understood that the processing underlying these screens will necessarily involve storage and retrieval of information related to the environments, projects, activities, workflows and schedules created by the user. Although there are a number of ways in which to organize such information, Appendix A to the present application provides entity-relationship diagrams illustrating the data model used to implement the present invention, according to a preferred embodiment. It is to be understood that various relational database management systems and related technology can be used to implement the storage and retrieval of information for the present invention, according to the entity-relationship diagram presented herein.

Note: In the following discussion “entities” are shown in bold and italicized.

The Plugin entity represents a plug-in or snap-on based architecture that allows a PluginType (e.g., Project Type or Activity Type or Schedule Type) to be added to the “Workhorse framework” by just modifying settings and not requiring code changes to the framework. E.g., “Email” is an Activity Type Plugin which is used to send emails. The framework used herein allows properties of the Plugin to be automatically displayed utilizing the Property Grid without requiring additional user interface programming.

A plug-in is an assembly program that is created utilizing a high level language like C#. E.g., Email is an Activity Type plug-in that is written in a high level language such as C# and contains logic to send email and defines properties that are required to send an email like the sender's and receiver's email addresses, email header, email body, etc. The present framework interprets the properties defined in the Email plug-in and renders these properties appropriately in the user interface as well as captures property values.

A PluginObject entity represents an actual PluginType (e.g. Project) that is instantiated as is the case when a new project (e.g. when a project called “PayrollProcess” is created). The properties of the PluginObject “PayrollProcess” are represented by the PluginObjectProperty entity.

The PropertyReference entity represents property references for properties of a Plugin. The PluginObjectPropertyReference entity associates a PropertyReference with a PluginObject (e.g. when “PayrollProcess” project uses a reference “WorkhorseConnectionString” value for a property). The PluginObjectPropertyValue entity represents a property value for a PluginObject (e.g., “C:\Users\arup\Documents\WorkingFolder”).

The Environment entity represents an execution environment (e.g., “Production”). The PluginObjectEnvironment entity represents a PluginObject in a particular environment (e.g. project “PayrollProcess” in the “Development” environment). The properties and references of the PluginObject in an environment are overridden using the PluginObjectPropertyEnvironment, PluginObjectPropertyEnvironmentValue and PropertyEnvironmentReference entities. The PluginObjectEnvironmentEventLog entity represents logging events that are generated by a PluginObject (project/activity/schedule) during the execution of a project.

The Project entity is a type of PluginObject that is used to create, execute and mange a workflow. The ProjectEnvironment entity represents a project in a particular environment. An Activity entity is a type of PluginObject used to perform a specific task.

The ActivityEnvironment entity represents an activity in a particular environment. The ActivityEvent entity represents all possible events that may be generated by an activity and the event handler activities that are executed when a particular event is generated.

The Schedule entity is a type of PluginObject used for scheduling a project. The Execution entity represents an execution run of a project. The Execution Type entity represents the type of execution (e.g. manual or scheduled). The Variable entity represents a variable that may be defined and used to define property values.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

### Appendix A

What is claimed is:

1. A web-based method, comprising:
assigning a first user-selected environment for a project;
assigning an identifier and a project domain for the project, the project domain selected from a list of project domains;
assigning a set of properties for the project, the set of properties for the project based on a template for the selected project domain; and
constructing a workflow for the project, the workflow including a plurality of activities, at least one of the activities configured to initiate at least one other activity in the workflow upon a predetermined run-time condition.

2. The method of claim 1, wherein constructing the workflow includes assigning a set of properties for each of the activities in the workflow, the set of properties for each set based on a respective template for a user-selected activity type.

3. The method of claim 1, further comprising assigning a second environment for the project.

4. The web-based method of claim 3, wherein at least one property of a project, an activity, or a schedule is inherited from the first environment.

5. The web-based method of claim 1, further comprising
scheduling the workflow.

6. The web-based method of claim 5, wherein scheduling the workflow includes assigning a set of properties for a project schedule, the set of properties for each set based on a respective template for a user-selected schedule type.

7. The computer-implanted method of claim 1, wherein the predetermined run-time condition includes one or more of a failed condition, a skipped condition, a completed condition, and a started condition in addition to other run-time conditions as required by an acitivity type.

8. The web-based method of claim 1, further comprising:
assigning a set of properties for the project, each of the set of activities and, optionally, a plurality of schedules, by:
for each of the sets of properties to be assigned,
displaying a property grid having a uniform format upon a screen, the property grid including a list of properties to be assigned based upon a predefined template; and
inputting a property value for each of the properties listed.

9. The web-based method of claim 8, wherein the property value is one of an absolute value, a reference, and an expression.

10. The web-based method of claim 8, wherein the property grid for the project is based on a user-selected project domain, and the property grids for each of the activities are based on user-selected activity types, and the property grids for each of the schedules are based on a user-selected schedule types.

11. The web-based method of claim 8, where the uniform format includes, for each property of the property grid, a row having one or more widget for inputting the property value of the property.

12. The web-based method of claim 11, wherein the uniform format includes a mechanism for indicating whether an inheritable property value is to be inherited or overridden.

13. The web-based method of claim 9, wherein the reference is automatically reflected across all property values which consume the reference.

14. The web-based method of claim 8, wherein the uniform format includes a look-up mechanism for extracting and displaying historical property values for property values so that they are selectable for input.

15. The web-based method of claim 9, wherein the expression is written in a syntax of a high-level programming language.

16. The web-based method of claim 1, wherein the first environment does not allow execution or scheduling of the workflow.

17. The web-based method of claim 1, wherein properties can only be inherited from properties created in the first environment.

18. A computer-implemented method, comprising:
assigning a first user-selected environment for a project;
assigning an identifier and a project domain for the project, the project domain selected from a list of project domains;
assigning a set of properties to the project, the set of properties for the project based on a template for the selected project domain;
constructing a workflow for the project, the workflow including a plurality of activities, at least one of the activities configured to initiate at least one other activity in the workflow upon a predetermined run-time condition; and
assigning a second environment for the project, the second environment including at least one property inherited from the first environment;
wherein constructing the workflow includes assigning a set of properties for each of the activities in the workflow, the set of properties for each set based on a respective template for a user-selected activity type.

19. The computer-implemented method of claim 18, wherein the first environment does not allow execution or scheduling of the workflow.

20. A computer-implemented method, comprising:
assigning an identifier and a project domain for the project, the project domain selected from a list of project domains;
assigning a set of properties to the project, the set of properties for the project based on a template for the selected project domain;
constructing a workflow for the project, the workflow including a plurality of activities, at least one of the activities configured to initiate at least one other activity in the workflow upon a predetermined run-time condition;
wherein constructing the workflow includes assigning a set of properties for each of the activities in the workflow, the set of properties for each set based on a respective template for a user-selected activity type.
